(19) United States
(12) Patent Application Publication
(10) Pub. No.: US 2018/0337562 A1
(43) Pub. Date: Nov. 22, 2018

(54) SELF-CHARGING ELECTRONIC DEVICE

(71) Applicant: HON HAI PRECISION INDUSTRY CO., LTD., New Taipei (TW)

(72) Inventor: YU-CHING HSU, New Taipei (TW)

(21) Appl. No.: 15/609,043

(22) Filed: May 31, 2017

(30) Foreign Application Priority Data
May 17, 2017 (CN) 201710348501.2

(51) Int. Cl. H02J 50/20; H02J 7/02; H02J 7/04

(52) U.S. Cl. CPC H02J 50/20; H02J 7/045; H02J 7/025

(57) ABSTRACT

A self-charging electronic device with its own independent and rechargeable power supply includes an antenna, an energy converting unit, and a power supply unit. The antenna acquires multi-band radio frequency signals in the surrounding environment. The energy converting unit receives the multi-band radio frequency signals from the antenna, and converts the multi-band radio frequency signals into a direct current voltage to continuously charge the power supply unit of the device.

### FIELD

The subject matter herein generally relates to electronic devices.

### BACKGROUND

Notebook computers, wireless mouse and wireless keyboard applications are popular. However, most wireless mouse and keyboards do not provide continuously power, thus, there is a need to be charged after use for a period of time.

### BRIEF DESCRIPTION OF THE DRAWINGS

Implementations of the present technology will now be described, by way of example only, with reference to the attached figures.

FIG. 1 is a schematic diagram of an exemplary embodiment of an electronic device with a radio frequency source.

FIG. 2 is a block diagram of the electronic device of FIG. 1.

FIG. 3 is a block diagram of an energy converting unit of the electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the exemplary embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected.

The term “comprising” means “including, but not necessarily limited to”; it specifically indicates open-ended inclusion or membership in a so-described combination, group, series, and the like.

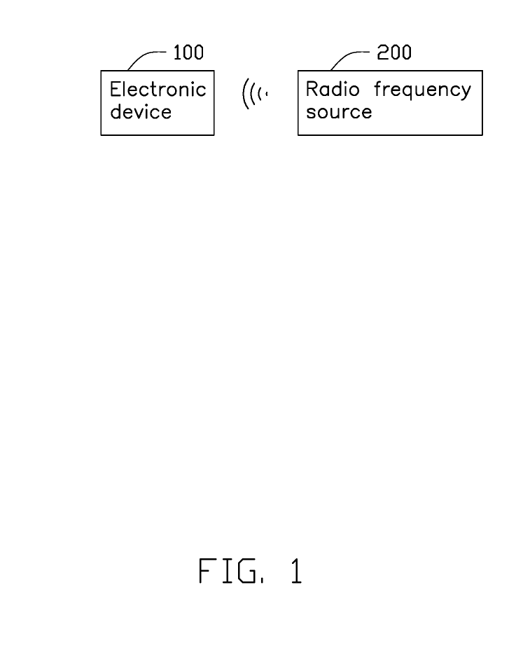

FIG. 1 illustrates an electronic device 100 in an exemplary embodiment. The electronic device 100 is used to receive a radio frequency (RF) signal from an RF source 200 in the surrounding environment, and convert the radio frequency signal into a direct current (DC) voltage signal.

In at least one exemplary embodiment, the electronic device 100 can be a wireless mouse.

In at least one exemplary embodiment, the electronic device 100 can be a wireless keyboard, a notebook computer, or other electronic products.

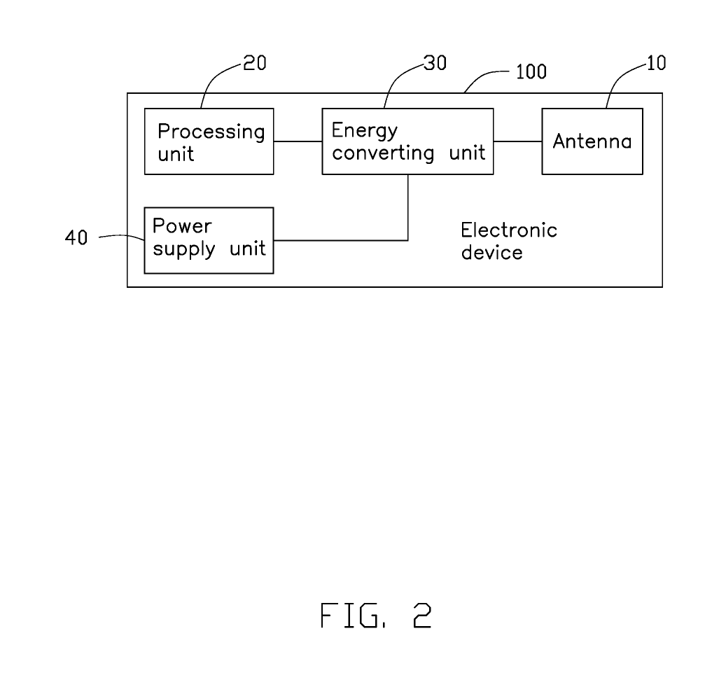

FIG. 2 illustrates that the electronic device 100 comprises an antenna 10, a processing unit 20, an energy converting unit 30, and a power supply unit 40.

In at least one exemplary embodiment, the antenna 10 acquires multi-band radio frequency signals in the surrounding environment, such as WI-FI signal or a cellular telephone signal, and transmits the multi-band radio frequency signals to the energy converting unit 30.

In at least one exemplary embodiment, the antenna 10 can be a patch antenna.

The antenna 10 receives the radio frequency signals in the industrial scientific medical (ISM) band at frequencies of 2.4 GHz and 5.8 GHz.

The antenna 10 may also receive the radio frequency signals at frequencies of 850 MHz to 900 MHz, 1.8 GHz to 1.9 GHz, and other 2G/3G/4G radio frequency signals.

In at least one exemplary embodiment, the energy converting unit 30 receives the multi-band radio frequency signals from the antenna 10, and converts the multi-band radio frequency signals into a direct current voltage to charge the power supply unit 40.

The power supply unit 40 provides an operating power source for the electronic device 100.

The energy converting unit 30 outputs the direct current voltage to charge the power supply unit 40.

In at least one exemplary embodiment, the power supply unit 40 can be a battery.

The processing unit 20 detects a power level of the power supply unit 40, and controls the energy converting unit 30 to perform energy conversion when the power level of the power supply unit 40 is less than a preset value.

The energy converting unit 30 converts the electromagnetic energy in the surrounding into the multi-band radio frequency signal and further converts into power for the power supply unit 40.

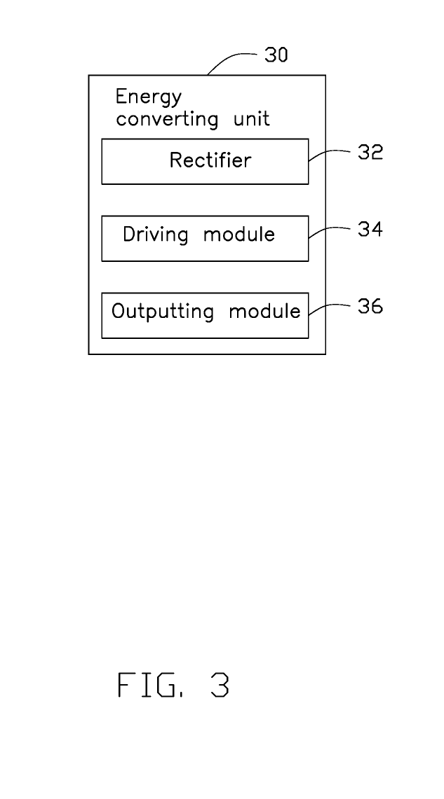

FIG. 3 illustrates that the energy converting unit 30 comprises a rectifier 32, a driving module 34, and an outputting module 36.

The rectifier 32 receives the multi-band radio frequency signals from the antenna 10, and converts the multi-band radio frequency signals into the direct current voltage.

The driving module 34 boosts or depresses the DC voltage outputted from the rectifier 32, to output the direct current voltage required for the power supply unit 40.

The outputting module 36 is electrically coupled to the power supply unit 40 to output the direct current voltage to charge the power supply unit 40.

When a user uses the electronic device 100, the processing unit 20 will detect the power level of the power supply unit 40.

When the power level of the power supply unit 40 is less than the preset value, the processing unit 20 will control the energy converting unit 30 to perform energy conversion.

The rectifier 32 can convert the multi-band radio frequency signal (such as a WI-FI signal and a cellular telephone signal in a public location) into a DC voltage. The driving module 34 boosts or depresses the DC voltage outputted from the rectifier 32 to output the direct current voltage required by the power supply unit 40. The outputting module 36 outputs the direct current voltage to the power supply unit 40 to charge the power supply unit 40.

Thus, the electronic device 100 acquires the multi-band radio frequency signals in the environment, such as the WI-FI signal and the cellular telephone signal, and converts the electromagnetic energy in the multi-band radio frequency signal into the DC voltage to continuously supply a charging voltage to the power supply unit 40, until the electronic device 100 is fully recharged. In this way, the electronic device 100 can be used continuously.

The exemplary embodiments shown and described above are only examples. Many details are often found in the art such as the other features of electronic device. Therefore, many such details are neither shown nor described.

Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

What is claimed is:

1. An electronic device comprising:
an antenna acquiring multi-band radio frequency signals in a surrounding environment;
a power supply supplying power to the electronic device;
an energy converting unit converting the multi-band radio frequency signals into a direct current voltage; and
a processing unit detecting a power level of the power supply;
wherein when the power level of the power supply unit is less than a preset value, the processing unit controls the energy converting unit to perform energy conversion and to output the direct current voltage to charge the power supply unit.

2. The electronic device of claim 1, wherein the energy converting unit comprises a rectifier, the rectifier receives the multi-band radio frequency signals from the antenna and converts the multi-band radio frequency signals into the direct current voltage.

3. The electronic device of claim 2, wherein the energy converting unit further comprises a driving module; wherein the driving module boosts or depresses the direct current voltage outputted from the rectifier to output the direct current voltage required by the power supply unit.

4. The electronic device of claim 3, wherein the energy converting unit further comprises an outputting module, the outputting module is electrically coupled to the power supply unit to output the direct current voltage to charge the power supply unit.

5. The electronic device of claim 1, wherein the antenna receives the radio frequency signals at a frequency of 2.4 GHz.

6. The electronic device of claim 1, wherein the antenna receives the radio frequency signal at a frequency of 5.8 GHz.

7. The electronic device of claim 1, wherein the antenna receives the radio frequency signal at frequencies of 850 MHz to 900 MHz.

8. The electronic device of claim 1, wherein the antenna receives the radio frequency signal at frequencies of 1.8 GHz to 1.9 GHz.

9. The electronic device of claim 1, wherein the antenna is a patch antenna.

10. The electronic device of claim 1, wherein the power supply unit is a battery.

11. An electronic device comprising:
an antenna acquiring multi-band radio frequency signals in a surrounding environment;
a power supply supplying power to the electronic device; and
an energy converting unit comprising:
a rectifier receiving the multi-band radio frequency signals from the antenna, and converting the multi-band radio frequency signals into a direct current voltage;
a processing unit detecting a power level of the power supply;
wherein when the power level of the power supply unit is less than a preset value, the processing unit controls the energy converting unit to perform energy conversion and to output the direct current voltage to charge the power supply unit.

12. The electronic device of claim 11, wherein the energy converting unit further comprises a driving module; wherein the driving module boosts or depresses the direct current voltage outputted from the rectifier to output the direct current voltage required by the power supply unit.

13. The electronic device of claim 2, wherein the energy converting unit further comprises an outputting module, the outputting module is electrically coupled to the power supply unit to output the direct current voltage to charge the power supply unit.

14. The electronic device of claim 11, wherein the antenna receives the radio frequency signal at a frequency of 2.4 GHz.

15. The electronic device of claim 11, wherein the antenna receives the radio frequency signal at a frequency of 5.8 GHz.

16. The electronic device of claim 11, wherein the antenna receives the radio frequency signal at frequencies of 850 MHz to 900 MHz.

17. The electronic device of claim 11, wherein the antenna receives the radio frequency signal at frequencies of 1.8 GHz to 1.9 GHz.

18. The electronic device of claim 11, wherein the antenna is a patch antenna.

19. The electronic device of claim 11, wherein the power supply unit is a battery.
